(19) United States
(12) Patent Application Publication
(10) Pub. No.: US 2024/0249481 A1
(43) Pub. Date: Jul. 25, 2024

(54) SMART EYEGLASSES AND METHOD FOR DISPLAYING IMAGE

(71) Applicant: SHENZHEN TCL DIGITAL TECHNOLOGY LTD., Shenzhen (CN)

(72) Inventor: Dahai YAO, Shenzhen (CN)

(21) Appl. No.: 18/564,122

(22) PCT Filed: Apr. 29, 2022
(86) PCT No.: PCT/CN2022/090116

§ 371 Date: Nov. 27, 2023

(30) Foreign Application Priority Data
May 31, 2021 (CN) 202110597235.3

(51) Int. Cl. G06T 19/00; G02B 27/01

(52) U.S. Cl. CPC G06T 19/006; G02B 27/0172; G02B 27/0176; G02B 2027/0178

(57) ABSTRACT

Smart eyeglasses (10) and a method for displaying an image. The smart eyeglasses (10) comprise: a display assembly (12) mounted in a frame (111), the display assembly comprising lenses (121) and transparent display screens (122) stacked on the lenses (121); and an image acquisition module (13) and a processing control module (14) which are arranged on the frame (11) and connected to the transparent display screens (122), the image acquisition module (13) being used for acquiring depth information of a real scene, the processing control module (14) being used for determining a virtual scene image to be displayed according to the depth information, and the transparent display screens (122) being used for displaying the virtual scene image.

SMART EYEGLASSES AND METHOD FOR DISPLAYING IMAGE

This application claims priority to Chinese Patent Application No. 202110597235.3, filed with the Chinese Patent Office on May 31, 2021, entitled “SMART EYEGLASSES AND METHOD FOR DISPLAYING IMAGE”, the disclosure of which is incorporated herein by reference in its entirety.

### TECHNICAL FIELD

The present application relates to the field of mixed reality technologies, and more particularly, to smart eyeglasses and a method for displaying an image.

### BACKGROUND

With the continuous development of technologies and concepts such as Augmented Reality (AR), Virtual Reality (VR), Extended Reality ( )R), Mixed Reality (MR), etc., consumers pay more and more attention to MR demand.

However, there are few MR products on the market at present, which are head-mounted devices that have completely stripped off a conventional glasses function and have poor usefulness.

### SUMMARY

### Technical Problems

The present application provides smart eyeglasses and a method for displaying an image, so as to enable the smart eyeglasses to have both the conventional glasses function and a mixed reality function, thereby improving the usefulness.

### SOLUTIONS TO PROBLEMS

### Technical Solutions

In order to solve the above problems, an embodiment of the present application provides smart eyeglasses, including: a support including both a frame and temples connected to the frame; a display assembly mounted in the frame and including both a lens and a transparent display screen stacked on the lens; and an image acquisition module and a processing control module both disposed on the support, where the processing control module is connected to both the image acquisition module and the transparent display screen, the image acquisition module is configured to acquire depth information of a real scene, the processing control module is configured to determine a virtual scene image to be displayed according to the depth information of the real scene, and the transparent display screen is configured to display the virtual scene image.

Where, the lens includes a lens liquid chamber and a lens liquid filled in the lens liquid chamber, where the lens liquid is gathered to a center portion of the lens liquid chamber or to a periphery portion of the lens liquid chamber under the action of the internal pressure of the lens liquid chamber, so as to change the concave-convex degree of the lens.

Where, the smart eyeglasses further include a pressure regulator disposed on the support and configured to regulate the internal pressure of the lens liquid chamber.

Where, the pressure regulator includes a pressure tube and a regulation piston located in the pressure tube, where the pressure tube is in communication with the lens liquid chamber, and the pressure regulator is configured to be moved back and forth within the pressure tube by regulating the regulation piston, to regulate the internal pressure of the lens liquid chamber.

Where, the pressure regulator is connected to the processing control module, where the processing control module is further configured to control the pressure regulator to regulate the internal pressure of the lens liquid chamber.

Where, the image acquisition module includes a front camera, a rear camera, a left camera, and a right camera, where the front camera, the rear camera, the left camera, and the right camera are located in front, rear, left, and right sides of the support, respectively.

Where, the smart eyeglasses further include a battery module disposed on the support and configured to supply power to the transparent display screen, the image acquisition module, and the processing control module.

Where, the transparent display screen is an organic light emitting diode display screen or a miniature light emitting diode display screen.

In order to solve the above problems, another embodiment of the present application provides a method for display an image, applied to the smart eyeglasses, where the smart eyeglasses include: a support including both a frame and temples connected to the frame; a display assembly mounted in the frame and including both lens and a transparent display screen stacked on the lens; and an image acquisition module and a processing control module both disposed on the support, where the processing control module is connected to both the image acquisition module and the transparent display screen, the image acquisition module is configured to acquire depth information of a real scene, the processing control module is configured to determine a virtual scene image to be displayed according to the depth information of the real scene, and the transparent display screen is configured to display the virtual scene image; and where the method includes: receiving a mixed reality instruction; acquiring the depth information of the real scene with the image acquisition module according to the mixed reality instruction; determining the virtual scene image to be displayed by the processing control module according to the depth information of the real scene; and displaying the virtual scene image with the transparent display screen.

Where, the mixed reality instruction includes a preset virtual scene image, and the determining of the virtual scene image to be displayed according to the depth information of the real scene specifically includes: determining depth information of a target area in the real scene from the depth information of the real scene; and adjusting depth information of the preset virtual scene image according to the depth information of the target area to obtain the virtual scene image to be displayed.

Where, the lens includes a lens liquid chamber and a lens liquid filled in the lens liquid chamber, where the lens liquid is gathered to a center portion of the lens liquid chamber or to a periphery portion of the lens liquid chamber under the action of the internal pressure of the lens liquid chamber, so as to change the concave-convex degree of the lens.

In the smart eyeglasses, the smart eyeglasses further include a pressure regulator disposed on the support and configured to regulate the internal pressure of the lens liquid chamber.

Where, the pressure regulator includes a pressure tube and a regulation piston located in the pressure tube, where the pressure tube is in communication with the lens liquid chamber, and the pressure regulator is configured to be moved back and forth within the pressure tube by regulating the regulation piston, to regulate the internal pressure of the lens liquid chamber.

Where, the pressure regulator is connected to the processing control module, where the processing control module is further configured to control the pressure regulator to regulate the internal pressure of the lens liquid chamber.

Where, the image acquisition module includes a front camera, a rear camera, a left camera, and a right camera, where the front camera, the rear camera, the left camera, and the right camera are located in front, rear, left, and right sides of the support, respectively.

Where, the smart eyeglasses further include a battery module disposed on the support and configured to supply power to the transparent display screen, the image acquisition module, and the processing control module.

Where, the transparent display screen is an organic light emitting diode display screen or a miniature light emitting diode display screen.

### BENEFICIAL EFFECTS OF INVENTION

### Beneficial Effects

Compared with the related art, the smart eyeglasses provided by the present application include a support, a display assembly, an image acquisition module and a processing control module, where the support includes both a frame and temples connected to the frame; a display assembly is mounted in the frame and including both a lens and a transparent display screen stacked on the lens; and an image acquisition module and a processing control module are both disposed on the support, where the processing control module is connected to both the image acquisition module and the transparent display screen, the image acquisition module is configured to acquire depth information of a real scene, the processing control module is configured to determine a virtual scene image to be displayed according to the depth information of the real scene, and the transparent display screen is configured to display the virtual scene image, so that a wearer of the smart eyeglasses can observe a mixed real scene formed by superimposing the virtual scene into the real scene through the transparent display screen and the lens, to realize stereo superposition display of the real reality and the virtual reality, and so that the smart eyeglasses can have both the conventional glasses function and the mixed reality function, thereby improving the usefulness of the smart eyeglasses.

### BRIEF DESCRIPTION OF THE DRAWINGS

### DESCRIPTION OF THE DRAWINGS

In order to more clearly illustrate the technical solutions in embodiments of the present application, the accompanying drawings depicted in the description of the embodiments will be briefly described below. It will be apparent that the accompanying drawings in the following description are merely some embodiments of the present application, and other drawings may be obtained from these drawings without creative effort by those skilled in the art.

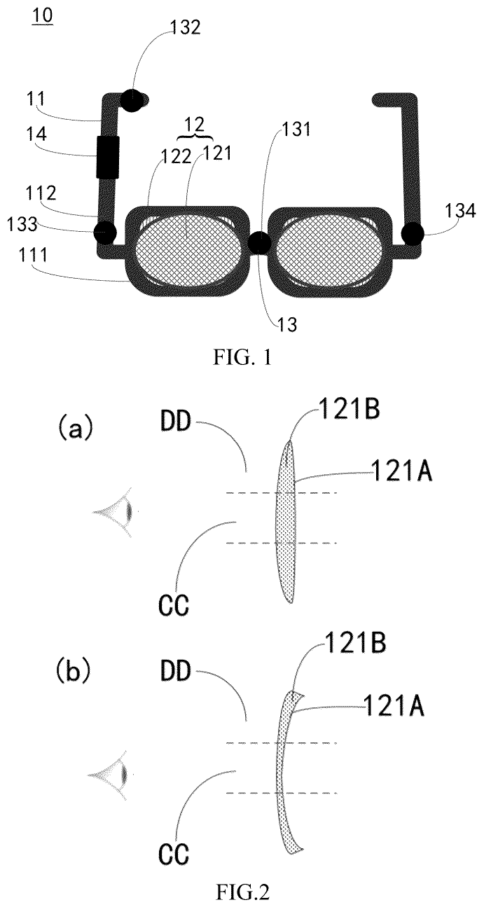

FIG. 1 is a schematic structural diagram of smart eyeglasses according to some embodiments of the present application.

FIG. 2 is a schematic diagram showing an effect of deformation of a lens according to some embodiments of the present application.

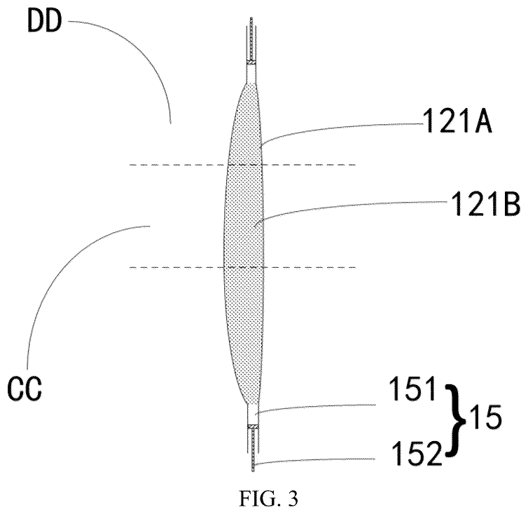

FIG. 3 is a schematic structural diagram of a lens and a pressure regulator according to some embodiments of the present application.

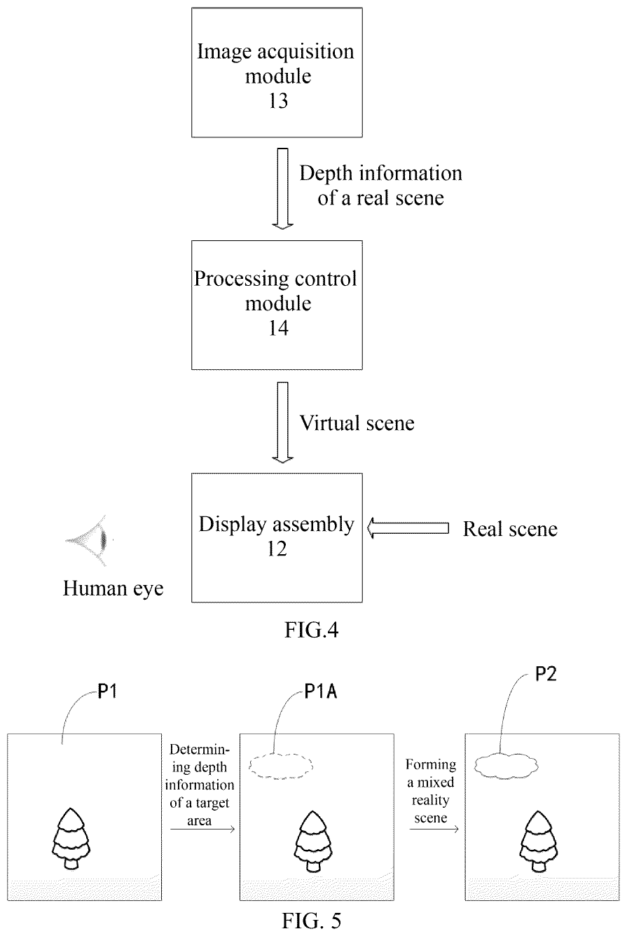

FIG. 4 is a flow diagram of forming a mixed reality scene according to some embodiments of the present application.

FIG. 5 is a schematic diagram showing display of an effect of forming a mixed reality scene according to some embodiments of the present application.

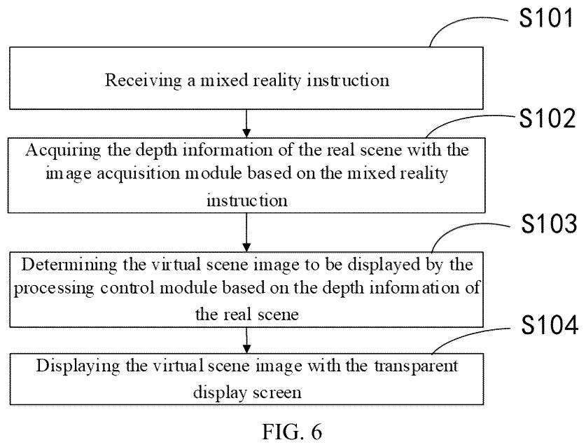

FIG. 6 is a flow diagram of a method for displaying an image according to some embodiments of the present application.

### EMBODIMENTS OF INVENTION

### DETAILED DESCRIPTION

The present application is described in further detail below with reference to the accompanying drawings and embodiments. It is specifically noted that the following embodiments are intended to illustrate the present application only, but do not limit the scope of the present application. Similarly, the following embodiments are only part and not all of the embodiments of the present application, and, all other embodiments obtained by those skilled in the art without creative work fall within the protection scope of the present application.

Additionally, the directional terms mentioned in the present application, such as [up], [down], [front], [back], [left], [right], [inner], [outer], [side], etc., are only the direction of the attached drawings. Therefore, the directional terms used are used to describe and understand the present application, rather than to limit the present application. In the drawings, units with similar structures are indicated by the same reference numerals.

There are few MR products on the market at present, which generally are MR wearable devices. Due to high system integration of the MR products, the MR products often have too complex structures, and are head-mounted devices that completely strip off the conventional glasses function and have poor usefulness. In addition, a user views a mixed reality scene through a display screen, and the mixed reality scene is rendered by a computer, but is not stereo superposition display of a real reality and a virtual reality. Therefore, the mixed reality effect of the existing MR products needs to be improved. In order to solve the above problems, technical solutions adopted by the present application is to provide smart eyeglasses and a method for displaying an image, so that the smart eyeglasses can implement stereo superposition display of the real reality and the virtual reality, and so that the smart eyeglasses can have both the conventional glasses function and the mixed reality function, thereby improving the mixed reality effect and the usefulness of the smart eyeglasses.

Please refer to FIG. 1, which is a schematic structural diagram of smart eyeglasses according to some embodiments of the present application. As shown in FIG. 1, the smart eyeglasses 10 may include a support 11, a display assembly 12, an image acquisition module 13, and a processing control module 14. The support 11 may include a frame 111 and temples 112 connected to the frame 111. The display assembly 12 is mounted in the frame 111, and may include one or more lenses 121 and one or more transparent display screens 122 stacked on the lenses 121. Specifically, the transparent display screen 122 may be disposed on an inner surface of the lens 121 (i.e., a side surface of a wearer's eyeball relatively close to the smart eyeglasses). The image acquisition module 13 and the processing control module 14 are disposed on the support 11, for example, on the temples 112.

In the embodiment, the processing control module 14 may be connected to the image acquisition module 13 and the transparent display screen 122. Specifically, the processing control module 14 may be electrically or communicatively connected to the image acquisition module 13 and the transparent display screen 122, the image acquisition module 13 may be configured to acquire depth information of a real scene, the processing control module 14 may be configured to determine a virtual scene image to be displayed according to the depth information of the real scene, and the transparent display screen 122 may be configured to display the virtual scene image, so that a wearer of the smart eyeglasses 10 can observe a mixed real scene formed by superimposing the virtual scene into the real scene through the transparent display screen 122 and the lens 121, and further so that the smart eyeglasses 10 can implement stereo superposition display of the real reality and the virtual reality, thereby enhancing a mixed real effect.

Specifically, when the transparent display screen 122 is not used, that is, no image is displayed on the display screen 122, the transparent display screen 122 is transparent. In this case, the smart eyeglasses may be used as ordinary glasses, that is, the wearer of the smart eyeglasses sees a real scene outside the display assembly 12 (a side relatively far from the eye of the wearer) through the display assembly 12. When the transparent display screen 122 is used, i.e., an image is displayed on the display screen 122, the image displayed by the transparent display screen 122 can completely or partially block the lens 121, so that the line of sight of the wearer cannot reach an area where the lens 121 is blocked by the image displayed by the transparent display screen 122. Further, when the image displayed on the transparent display screen 122 completely blocks the lens 121, the wearer corresponding to the smart eyeglasses can only see the image displayed on the transparent display screen 122, but cannot see the real scene outside the display assembly 12 through the transparent display screen 122. Alternatively, when the image displayed on the transparent display screen 122 partially blocks the lens 121, the wearer corresponding to the smart eyeglasses can see not only the image displayed on the transparent display screen 122, but also the real scene outside an area where the lens is not blocked by the image displayed on the transparent display screen 122 through the area.

In one embodiment, as shown in FIG. 1, the boundary of the lens 121 may be located within the boundary of the transparent display screen 122, or may coincide with the boundary of the transparent display screen 122. Accordingly, when the transparent display screen 122 fully displays the image, the image displayed by the transparent display screen 122 completely blocks the lens 121, so that the wearer of the smart glasses 10 can only see the image displayed by the transparent display screen 122, and cannot see the real scene outside the display assembly 12 through the transparent display screen 122. Further, when the transparent display screen 122 does not fully display the image, that is, a portion of the transparent display screen 122 does not display the image, the image displayed on the transparent display screen 122 may completely block the lens 121, or may partially block the lens 121.

In another embodiment, the boundary of the lens 121 may also be located outside the boundary of the transparent display screen 122. Accordingly, when the transparent display screen 122 displays the image, the image displayed on the transparent display screen 122 cannot completely block the lens 121, so that the wearer of the smart eyeglasses 10 can see not only the image displayed on the transparent display screen 122, but also the real scene outside an area where the lens 121 is not blocked by the transparent display screen 122 through the area.

In the present embodiment, the transparent display screen 122 may display an image of a virtual scene (that is, the virtual scene image), and the image of the virtual scene displayed on the transparent display screen 122 does not completely block the lens 121, so that the wearer of the smart eyeglasses 10 observes an image formed by superimposing the real scene and the virtual scene displayed on the transparent display screen 122, thereby improving the stereoscopic sense of a mixed reality scene seen by the wearer.

In the above-described embodiment, the temples 112 may be rotatably connected to the frame 111 by a hinge or a rotating shaft. The transparent display screen 122 may be an organic light emitting diode display screen (OLED) or an Micro light emitting diode display screen (Micro LED). The lens 121 may be a transparent lens and have a material of a resin. Further, the transparent display screen 122 and the lens 121 may be fixed together by a transparent optical adhesive to prevent relative deviation of both the transparent display screen 122 and the lens 121.

In particular, opposite ends (for example, the left end and the right end, or the upper end and the lower end) of the interior of the frame 111 may be provided with snaps (not shown), respectively, through which the transparent display screen 122 and/or the lens 121 in the display assembly 12 may be snapped into the frame 111. Specifically, the frame 111 may be a half-frame or a full-frame structure, and the frame 111 may include a left frame and a right frame corresponding to the left and right eyes of a person. Accordingly, the lens 121 may include a left lens mounted in the left frame and a right lens mounted in the right frame. The temples 112 may include a left temple connected to the left frame and a right temple connected to the right frame. The transparent display screen 122 may include a first transparent display screen provided on the inner side surface of the left lens and a second transparent display screen provided on the inner side surface of the right lens. In some embodiments, the support 11 may further include a nose pad (not shown), and the left frame and the right frame may be symmetrically disposed on both left and right sides of the nose pad.

It should be understood that a specific structure of the support 11 in the above-described smart eyeglasses 10 may refer to the specific structure of the support in conventional glasses (e.g., myopia glasses, hyperopia glasses, or sunglasses), i.e., the support 11 of the above-described smart eyeglasses 10 may have the same or similar structure and/or shape as that of the conventional glasses. As described above, when the transparent display screen 122 of the smart eyeglasses 10 does not display the image, the smart eyeglasses 10 can be used as ordinary glasses, so that the smart eyeglasses 10 can have both the conventional glasses function and the mixed reality function.

In one specific embodiment, as shown in (a) and (b) of FIG. 2, the inner surface of the lens 121 is opposite to the human eye, and the lens 121 may include a lens liquid chamber 121A and a lens liquid 121B filled in the lens liquid chamber 121A. The lens liquid 121B may be gathered to a center portion CC of the lens liquid chamber 121A (as shown in (a) of FIG. 2) or may be gathered to a periphery portion DD of the lens liquid chamber 121A (as shown in (b) of FIG. 2) under the action of the internal pressure of the lens liquid chamber 121A, so the concave-convex degree of the lens 121 may be changed. That is, the lens 121 may be deformed, so that the lens 121 is converted among a convex lens, a flat mirror, and a concave lens.

Specifically, when the internal pressure of the lens liquid chamber 121A is gradually decreased, the lens liquid 121B may be gradually gathered to the center portion CC of the lens liquid chamber 121A, and the lens liquid chamber 121A is outwardly expanded to form a convex lens. When the internal pressure of the lens liquid chamber 121A is gradually decreased, the lens liquid 121B may be gradually gathered to the periphery portion DD of the lens liquid chamber 121A, and the lens liquid chamber 121A may be inwardly compressed to form a concave lens. In addition, different degrees of the lens 121 can be accurately adjusted by controlling the degree to which the lens liquid chamber 121A is inwardly compressed or outwardly expanded. Specifically, the degree of the lens 121 may be in a regulatable range of −700 to +500 degrees, and the degree can be changed across the common range values of the myopia glasses and the hyperopia glasses, so that the lens 121 can be used by different populations, thereby greatly improving the usefulness of the smart eyeglasses 10.

The lens liquid chamber 121A may be a hollow chamber made of a transparent flexible material, and the lens liquid 121B may be a transparent liquid, for example, a transparent high refractive liquid.

In one specific embodiment, as shown in FIG. 3, the smart eyeglasses 10 may further include a pressure regulator 15 that may be disposed on the support 11, for example, embedded within the frame 111, and that may be used to regulate the internal pressure of the lens fluid chamber 121A. Specifically, the user of the smart eyeglasses 10 can regulate the internal pressure of the lens liquid chamber 121A by manually controlling the pressure regulator 15 or controlling the pressure regulator 15 with the processing control module 14.

In particular, as shown in FIG. 3, the pressure regulator 15 may include a pressure tube 151 and a regulation piston 152 located in the pressure tube 151, where the pressure tube 151 is in communication with the lens liquid chamber 121A, and the pressure regulator 15 is configured to be moved back and forth within the pressure tube 151 by the regulation piston 152, to regulate the internal pressure of the lens liquid chamber 121A. Specifically, when the regulation piston 152 is moved in the pressure tube 151 in a direction away from the lens liquid chamber 121A, the internal pressure of the lens liquid chamber 121A may be decreased, or even become negative, thereby forcing the lens liquid 121B in the lens liquid chamber 121A to be gathered to the periphery portion DD of the lens liquid chamber 121A. When the regulation piston 152 is moved in the pressure tube 151 in the direction close to the lens liquid chamber 121A, the internal pressure of the lens liquid chamber 121A may be increased, thereby forcing the lens liquid 121B in the lens liquid chamber 121A to be gathered to the center portion CC of the lens liquid chamber 121A. Specifically, as shown in FIG. 3, each of the lenses 121 may correspond to two pressure regulators 15, which may be in communication with opposite ends (e.g., a left end and a right end, or an upper end and a lower end) of the lens liquid chamber 121A, respectively.

In some embodiments, the pressure regulator 31 may be connected to the processing control module 14, which may be further configured to control the regulation piston 152 to be moved back and forth within the pressure tube 151 to implement regulation of the internal pressure of the lens fluid chamber 121A.

In the present embodiment, the processing control module 14 is a control center of the smart eyeglasses 10, and may be connected to various parts of the entire smart eyeglasses 10 (for example, the transparent display screen 122, the image acquisition module 13, and the pressure regulator 15) by various interfaces and lines. Specifically, the processing control module 14 may be an Microcontroller Unit (MCU) module, and may be specifically an embedded MCU module. Accordingly, the processing control module 14 may be disposed inside the support 11, for example, inside the temples 112. Specifically, the MCU module may consist of a central processing unit, a non-volatile memory, a volatile memory, a peripheral device, and a supporting circuit.

In the present embodiment, the image acquisition module 13 is configured to acquire depth information of a real scene (or real world), where the depth information may be a depth value or a field depth value. Specifically, as shown in FIG. 1, the image acquisition module 13 may include a plurality of cameras, for example, may include a front camera 131, a rear camera 132, a left camera 133, and a right camera 134, which may be located in front, rear, left, and right sides of the support 11 to obtain depth information of the real scene in multiple directions. Specifically, the camera may be an imaging device supporting stereoscopic image shooting, such as a 3D deep sensing camera.

The principle of implementing mixed reality by the above-mentioned smart eyeglasses can be shown in FIG. 4. The image acquisition module 13 transmits depth information of the real scene acquired by the image acquisition module 13 to the processing control module 14, and then the processing control module 14 determines a virtual scene image to be displayed according to the depth information of the real scene and transmits the virtual scene image to the transparent display screen 122 of the display assembly 12 for display, and a wearer's eye corresponding to the smart eyeglasses 10 can see a mixed reality scene formed by superimposing the virtual scene into the real scene.

Specifically, as shown in FIG. 5, the processing control module 14 determines the virtual scene image to be displayed according to the depth information of the real scene, and may be implemented by: determining depth information of a target area PIA in the real scene P1 from the depth information of the real scene P1, where the target area P1A is an area where the virtual scene image P2 is superimposed into the real scene P1; and adjusting depth information of a preset virtual scene image according to the depth information of the target area PIA to obtain a virtual scene image P2 to be displayed. The preset virtual scene image may be a preset image (e.g., a white cloud image), and may be stored in a memory included in the processing control module 14 in advance, or may be carried in a mixed display instruction received by the smart eyeglasses 10. In particular, the adjusting of the depth information of the preset virtual scene image according to the depth information of the target area P1A may be specifically implemented by: adjusting the depth information of the preset virtual scene image to be consistent with the depth information (for example, average depth information) of the target area P1A in the real scene P1, to obtain the virtual scene image to be displayed P2. Thereafter, the transparent display screen 122 can display the virtual scene image P2, and the wearer corresponding to the smart eyeglasses 10 can see a mixed reality scene formed by superimposing the virtual scene image P2 into the real scene P1. In this case, the target area PIA in the real scene P1 can be blocked by the virtual scene image P2 displayed on the transparent display screen 122, but cannot be viewed by the wearer. In this way, it is beneficial to improving the sense of reality of the mixed reality scene and greatly improving the fusion effect of the real scene and the virtual scene.

In the above-described embodiments, the smart eyeglasses may further include a battery module (not shown) disposed on the support 11, which may be configured to supply power to devices or modules of the smart eyeglasses 10 requiring power consumption, such as the transparent display screen 122, the image acquisition module 13, and/or the processing control module 14. Specifically, the battery module and the processing control module 14 may be disposed in the left temple and the right temple of the smart eyeglasses 10, respectively. The battery module may be specifically a rechargeable lithium battery.

In some embodiments, the smart eyeglasses 10 may further include a sensor such as an inertial sensor, a gravity sensor, and the like, and may be interacted with an external device supporting the sensor after being connected with the external device via Wi-Fi or Blue-tooth.

Compared with the related art, the smart eyeglasses provided by the present embodiment include a support, a display assembly, an image acquisition module and a processing control module, where the support includes both a frame and temples connected to the frame; a display assembly is mounted in the frame and including both a lens and a transparent display screen stacked on the lens; and an image acquisition module and a processing control module are both disposed on the support, where the processing control module is connected to both the image acquisition module and the transparent display screen, the image acquisition module is configured to acquire depth information of a real scene, the processing control module is configured to determine a virtual scene image to be displayed according to the depth information of the real scene, and the transparent display screen is configured to display the virtual scene image, so that a wearer of the smart eyeglasses can observe a mixed real scene formed by superimposing the virtual scene into the real scene through the transparent display screen and the lens, to realize stereo superposition display of the real reality and the virtual reality, and so that the smart eyeglasses can have both the conventional glasses function and the mixed reality function, thereby improving the usefulness of the smart eyeglasses.

Please refer to FIG. 6, which is a flow diagram of a method for displaying an image according to some embodiments of the present application. The method can be applied to the smart eyeglasses of any of the above embodiments. The smart eyeglasses can include a support, a display assembly, an image acquisition module and a processing control module, where the support includes both a frame and temples connected to the frame; a display assembly is mounted in the frame and including both a lens and a transparent display screen stacked on the lens; and an image acquisition module and a processing control module are both disposed on the support, where the processing control module is connected to both the image acquisition module and the transparent display screen, the image acquisition module is configured to acquire depth information of a real scene, the processing control module is configured to determine a virtual scene image to be displayed according to the depth information of the real scene, and the transparent display screen is configured to display the virtual scene image, so that a wearer of the smart eyeglasses can observe a mixed real scene formed by superimposing the virtual scene into the real scene through the transparent display screen and the lens. The description of the above-mentioned smart eyeglasses has been described in detail in the above-mentioned embodiments, which is not repeatedly described herein. Specifically, as shown in FIG. 6, a specific flow of the method may include steps S101-S104 as follows.

At step S101, a mixed reality instruction is received.

Specifically, the smart eyeglasses may receive a mixed reality instruction through the processing control module. The mixed reality instruction may be generated by a user turning on the mixed reality function of the smart eyeglasses to trigger the smart eyeglasses, or may be transmitted to the processing control module of the smart eyeglasses by an external device connected to the processing control module through the Wi-Fi or the Blue-tooth.

At step S102, the depth information of the real scene is acquired with the image acquisition module according to the mixed reality instruction.

Specifically, the smart eyeglasses can acquire the depth information of the real scene with the image acquisition module according to the mixed reality instruction through the processing control module. The depth information of the real scene may be a depth value or a field depth value of the real scene.

At step S103, the virtual scene image to be displayed is determined by the processing control module according to the depth information of the real scene.

The step S103 may be specifically implemented by following steps S1031-S1032.

At step S1031, depth information of a target area in the real scene is determined from the depth information of the real scene.

At step S1032, depth information of the preset virtual scene image is adjusted according to the depth information of the target area to obtain the virtual scene image to be displayed.

The preset virtual scene image may be a preset image (for example, a white cloud image), and may be stored in a memory included in the processing control module in advance, or may be carried in the mixed reality instruction. The target area can be an area where the virtual scene image may be superimposed into a subsequent real scene.

Specifically, the smart eyeglasses can adjust the depth information of the preset virtual scene image according to the depth information of the target area by the processing control module to obtain the virtual scene to be displayed. For example, the processing control module can adjust the depth information of the preset virtual scene image to be consistent with the depth information of the target area in the real scene (for example, the average depth information) to obtain the virtual scene image to be displayed.

At step S104, the virtual scene image is displayed with the transparent display screen.

Specifically, the smart eyeglasses may display the virtual scene image with the transparent display screen through the processing control module, and the wearer's eyes of the smart eyeglasses may observe a mixed reality scene formed by superimposing the virtual scene image into a real scene through the transparent display screen and the lens. In this case, the target area in the real scene is blocked by the virtual scene image displayed on the transparent display screen, and cannot be seen by the wearer. In this way, it is beneficial to improving the sense of reality of the mixed reality scene and greatly improving the fusion effect of the real scene and the virtual scene.

Compared with the related art, the method for displaying the image in the present application is applied to the smart eyeglasses, in the method, a mixed reality instruction is received, the depth information of the real scene is acquired with the image acquisition module according to the mixed reality instruction, then a virtual scene image to be displayed is determined according to the depth information of the real scene by a processing control module, and the virtual scene image is displayed by the transparent display screen, so that the wearer of the smart eyeglasses can observe the mixed real scene formed by superimposing the virtual scene into the real scene through the transparent display screen and the lens, to realize stereo superposition display of the real reality and the virtual reality, and so that the smart eyeglasses can have both the conventional glasses function and the mixed reality function, thereby improving the usefulness of the smart eyeglasses.

It should be understood that the foregoing description is only specific embodiments of the present application, and is not intended to limit the scope of the present application, and that any modifications, equivalents, modifications and the like, which fall within the spirit and principles of the present application, are intended to be included within the scope of the present application.

What is claimed is:

1. Smart eyeglasses, comprising:
a support including both a frame and temples connected to the frame;
a display assembly mounted in the frame and including both a lens and a transparent display screen stacked on the lens; and
an image acquisition module and a processing control module both disposed on the support, wherein the processing control module is connected to both the image acquisition module and the transparent display screen, the image acquisition module is configured to acquire depth information of a real scene, the processing control module is configured to determine a virtual scene image to be displayed based on the depth information of the real scene, and the transparent display screen is configured to display the virtual scene image.

2. The smart eyeglasses of claim 1, wherein the lens includes a lens liquid chamber and a lens liquid filled in the lens liquid chamber, and the lens liquid is gathered to a center portion of the lens liquid chamber or to a periphery portion of the lens liquid chamber under the action of an internal pressure of the lens liquid chamber to change a concave-convex degree of the lens.

3. The smart eyeglasses of claim 2, further comprising: a pressure regulator disposed on the support and configured to regulate the internal pressure of the lens liquid chamber.

4. The smart eyeglasses of claim 3, wherein the pressure regulator includes:
a pressure tube and a regulation piston located in the pressure tube, the pressure tube is in communication with the lens liquid chamber, and the pressure regulator is configured to be moved back and forth within the pressure tube by regulating the regulation piston, to regulate the internal pressure of the lens liquid chamber.

5. The smart eyeglasses of claim 3, wherein the pressure regulator is connected to the processing control module, and the processing control module is further configured to control the pressure regulator to regulate the internal pressure of the lens liquid chamber.

6. The smart eyeglasses of claim 1, wherein the image acquisition module includes a front camera, a rear camera, a left camera, and a right camera, and the front camera, the rear camera, the left camera, and the right camera are located in front, rear, left, and right sides of the support, respectively.

7. The smart eyeglasses of claim 1, further comprising: a battery module disposed on the support and configured to supply power to the transparent display screen, the image acquisition module, and the processing control module.

8. The smart eyeglasses of claim 1, wherein the transparent display screen is an organic light emitting diode display screen or a miniature light emitting diode display screen.

9. A method for display an image, applied to smart eyeglasses, wherein the smart eyeglasses comprise:
a support including both a frame and temples connected to the frame;
a display assembly mounted in the frame and including both a lens and a transparent display screen stacked on the lens; and
an image acquisition module and a processing control module both disposed on the support, wherein the processing control module is connected to both the image acquisition module and the transparent display screen, the image acquisition module is configured to acquire depth information of a real scene, the processing control module is configured to determine a virtual scene image to be displayed according to the depth information of the real scene, and the transparent display screen is configured to display the virtual scene image;
and wherein the method comprises:
receiving a mixed reality instruction;
acquiring the depth information of the real scene with the image acquisition module based on the mixed reality instruction;
determining the virtual scene image to be displayed by the processing control module based on the depth information of the real scene; and
displaying the virtual scene image with the transparent display screen.

10. The method of claim 9, wherein the mixed reality instruction includes a preset virtual scene image, and the determining of the virtual scene image to be displayed based on the depth information of the real scene specifically includes:
determining depth information of a target area in the real scene from the depth information of the real scene; and
adjusting depth information of the preset virtual scene image based on the depth information of the target area to obtain the virtual scene image to be displayed.

11. The method of claim 9, wherein the lens includes a lens liquid chamber and a lens liquid filled in the lens liquid chamber, and the lens liquid is gathered to a center portion of the lens liquid chamber or to a periphery portion of the lens liquid chamber under the action of the internal pressure of the lens liquid chamber to change a concave-convex degree of the lens.

12. The method of claim 11, wherein the smart eyeglasses further comprises:
a pressure regulator disposed on the support and configured to regulate the internal pressure of the lens liquid chamber.

13. The method of claim 12, wherein the pressure regulator includes: a pressure tube and a regulation piston located in the pressure tube, the pressure tube is in communication with the lens liquid chamber, and the pressure regulator is configured to be moved back and forth within the pressure tube by regulating the regulation piston, to regulate the internal pressure of the lens liquid chamber.

14. The method of claim 12, wherein the pressure regulator is connected to the processing control module, and the processing control module is further configured to control the pressure regulator to regulate the internal pressure of the lens liquid chamber.

15. The method of claim 9, wherein the image acquisition module includes a front camera, a rear camera, a left camera, and a right camera, and the front camera, the rear camera, the left camera, and the right camera are located in front, rear, left, and right sides of the support, respectively.

16. The method of claim 9, wherein the smart eyeglasses further comprise: a battery module disposed on the support and configured to supply power to the transparent display screen, the image acquisition module, and the processing control module.

17. The method of claim 9, wherein the transparent display screen is an organic light emitting diode display screen or a miniature light emitting diode display screen.
